(19) United States
(12) Patent Application Publication
(10) Pub. No.: US 2005/0009463 A1
(43) Pub. Date: Jan. 13, 2005

(54) Automated processing method for fish and installation for preparing and processing fish, particularly for slaughtering and gutting the same

(76) Inventors: Werner Grosseholz, Krummessee (DE); Carsten Paulsohn, Lubeck (DE); Manfred Peters, Schwartau (DE); Andreas Dann, Lubeck (DE)

Correspondence Address: MATTINGLY, STANGER & MALUR, P.C., 1800 DIAGONAL ROAD, SUITE 370, ALEXANDRIA, VA, 22314, US

(21) Appl. No.: 10/485,333

(22) PCT Filed: Aug. 3, 2002
(86) PCT No.: PCT/EP02/08678

(30) Foreign Application Priority Data
Aug. 3, 2001 (DE) 101 37 651.0

(51) Int. Cl. A22B 7/00; A22C 18/00

(52) U.S. Cl. 452/179

(57) ABSTRACT

An automated processing method for fish and an installation for preparing and processing fish has a conveying element for linking a central feed device to a processing machine for processing fish. A number of machines are combined in an installation and are supplied with fish via the central feed belt. Fish are transferred from the central feed device by the conveying element so that the fish automatically reach the respective entry position of the processing machine.

The invention is concerned with an installation for the preparation and processing of fish, in particular for the slaughter and gutting thereof, essentially including a transport device for fish, a central storage tank for holding or for collecting the fish delivered, at least two processing machines for processing the fish, and a central delivery device for delivering the fish to each processing machine. Furthermore, the invention concerns a conveying element for linking a central delivery device to a processing machine for processing fish, essentially including a chute. The invention likewise includes a method for the automated processing of fish, essentially including the steps of delivery and collection of the fish in a central storage tank, separation of the fish, manual alignment of the fish into a predefined position, and automated processing of the fish.

Known plants have a single processing machine, for example an apparatus for slaughtering and gutting the fish, as known from document DE 198 29 376. Directly on this apparatus is located a storage recess for holding and for collecting the fish conveyed by the transport device into the storage recess. An operator individually takes the fish to be processed on the apparatus from the storage recess, and delivers them to the apparatus in a predefined position. Slaughter and gutting are then effected automatically by the apparatus. There are, however, already plants in which several machines have been combined in one plant, where the individual machines are supplied with fish by means of a central delivery belt. The fish are guided on the individual machines from the delivery belt and delivered to a storage recess. In this storage recess the fish lie untidily and must be separated and aligned again. An operator is required on each machine for this. The known plants and methods, however, all have the drawback that they are very personnel-intensive, as one operator is required at least on each apparatus in a plant to enable the apparatuses to be supplied with fish in parallel. A continuous process cycle is therefore cost-intensive.

It is thus the object of the invention to propose a method with which continuous processing of fish on several processing machines simultaneously is ensured, with processing to be carried out at reduced personnel cost. Furthermore, it is the object of the invention to provide an installation with which the method according to the invention can be carried out. It is a further object of the invention to provide an interface between a central delivery device and a processing machine.

The object is achieved with an installation with the characteristics mentioned herein-before by the fact that in the region of each processing machine for processing the fish the delivery device comprises means for transfer of the fish from the delivery device to each processing machine, wherein the means for transfer are designed in such a way that the fish move automatically to the respective input position of the processing machine. This installation according to the invention makes it possible for the first time for several processing machines to be used at the same time, wherein all the processing machines connected to the delivery device are operated by a single operator. After laying the fish on the delivery device, the delivery device and the means for transfer in joint co-ordination carry out automated filling/supply of the connected processing machines.

Advantageously, the plant has a central computer unit for control and/or regulation, by means of which all components can be controlled and/or regulated according to demand and/or priority and/or position. This ensures that the plant can be adjusted individually to achieve a continuous process cycle, in particular without down/standstill times of the individual processing stations.

In a particularly preferred installation, the means for transfer is designed as an active conveying element. As a result, it is reliably ensured that the fish, independently of their condition with respect to age, moisture and the like, are delivered to the processing machine being controlled at the time.

A preferred embodiment of the installation comprises active conveying means which are designed as storage buffers. This buffer function allows compensation for empty spots on the delivery belt, for example in the event that the single operator who is aligning the fish on the delivery belt fails to lay fish on the delivery belt continuously. The processing machines can then be supplied with fish from the storage buffer.

Advantageously, the storage buffer comprises several holding compartments for holding a single fish each, wherein the holding compartments are separated from each other by pivotable flaps, slides or the like. This ensures that the fish remain in their separated position, so that delivery or introduction of the fish into the processing machines can be effected without further intervention by an operator.

Furthermore, the object is achieved by a conveying element with the characteristics of the introductory part of claim 25, by the fact that the chute is inclined in two planes in such a way that each fish automatically moves from the delivery device over the chute directly into the input position of the processing machine. In other words, the chute being inclined in space ensures that the fish on the former move without active conveying means and/or hire of operating personnel into the processing machine.

Preferably the chute comprises at least one receptacle for the storage or stocking of a fish, so that irregularities in delivery of the fish can be compensated.

In a particularly preferred embodiment of the conveying element, the last receptacle of the chute before the processing station is designed or arranged in such a way that the fish is aligned with its longitudinal axis essentially parallel to the discharge edge of the processing machine. This ensures that the fish also slides or drops parallel into the receptacle of the processing station. This prevents tilting or wedging of the fish in the input or delivery to the processing machine, which leads to stopping and hence to interruption of the whole process.

Also, the object of the invention is achieved by a method together with the abovementioned steps, by the fact that before automated processing the fish are laid on a central delivery device and aligned and then delivered to the processing machines for processing, wherein the fish are passed through from the delivery device by a means for transfer to the respective processing station according to demand and priority.

An advantageous development of the method according to the invention is further characterised by the fact that, with monitoring means and a master computer unit for the control and/or regulation of all components with reference to demand messages and/or priority commands of the delivery device and/or the processing machines and/or means for transfer, it is determined where the next fish is deposited each time. This ensures that the processing machines can be permanently supplied with fish. Thus, for example, the processing machine arranged locally furthest from the central storage tank can be given a preference priority, because delivery takes more time compared with processing machines positioned closer.

Advantageously, after a calming period the fish are guided into a subsequent receptacle in the direction of the processing machine, provided that the monitoring means of the subsequent receptacle has indicated a demand. “Demand” means in this connection that the receptacle is empty and waiting for the next fish. Due to this development of the method controlled according to demand and priority, fish are at least always arranged in the receptacle closest to the processing station, ensuring continuous delivery into the processing station.

Further preferred characteristics and/or steps of the method can be found in the subsidiary claims and the description. Particularly preferred developments, embodiments and steps are described in more detail with the aid of the attached drawings. The drawings show:

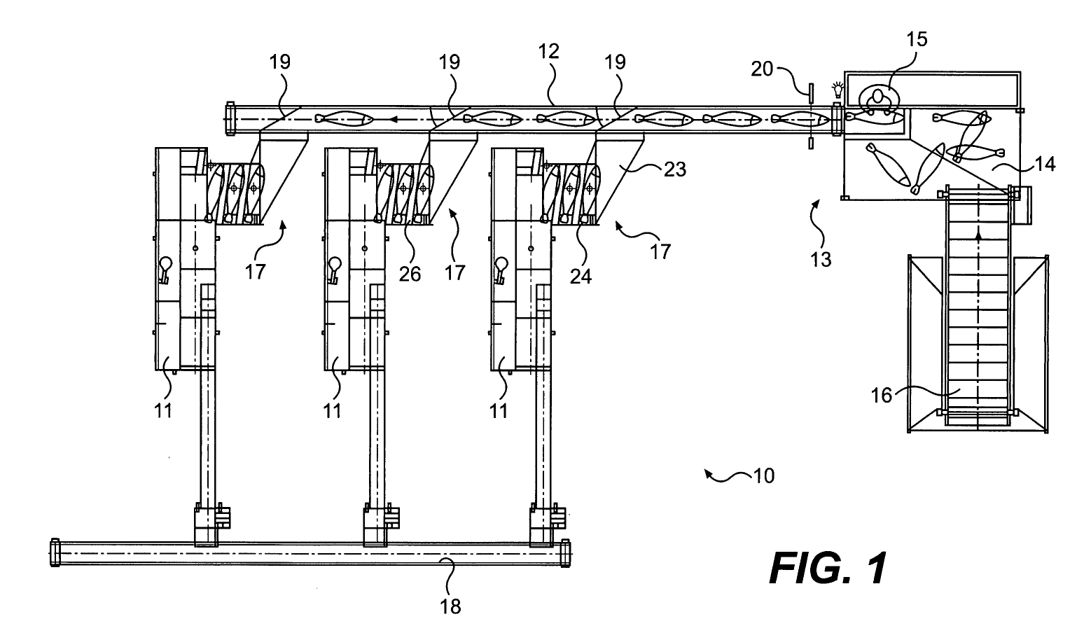

FIG. 1 a first installation according to the invention with three processing machines,

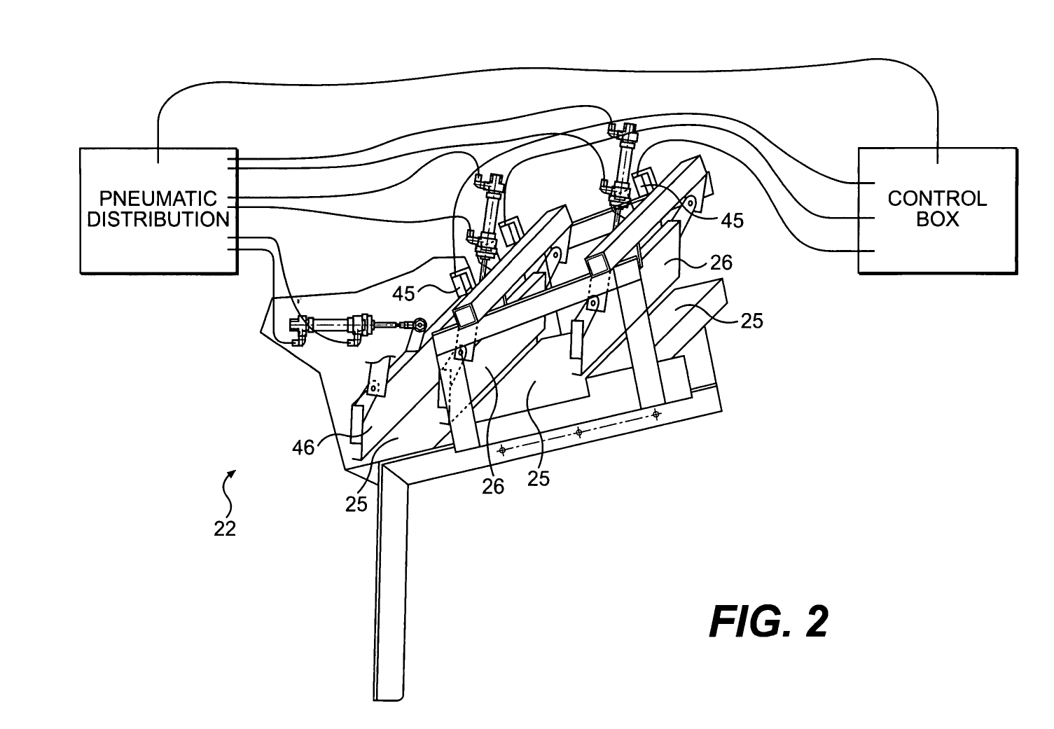

FIG. 2 a conveying element for connecting the delivery device to the processing stations, as shown in FIG. 1,

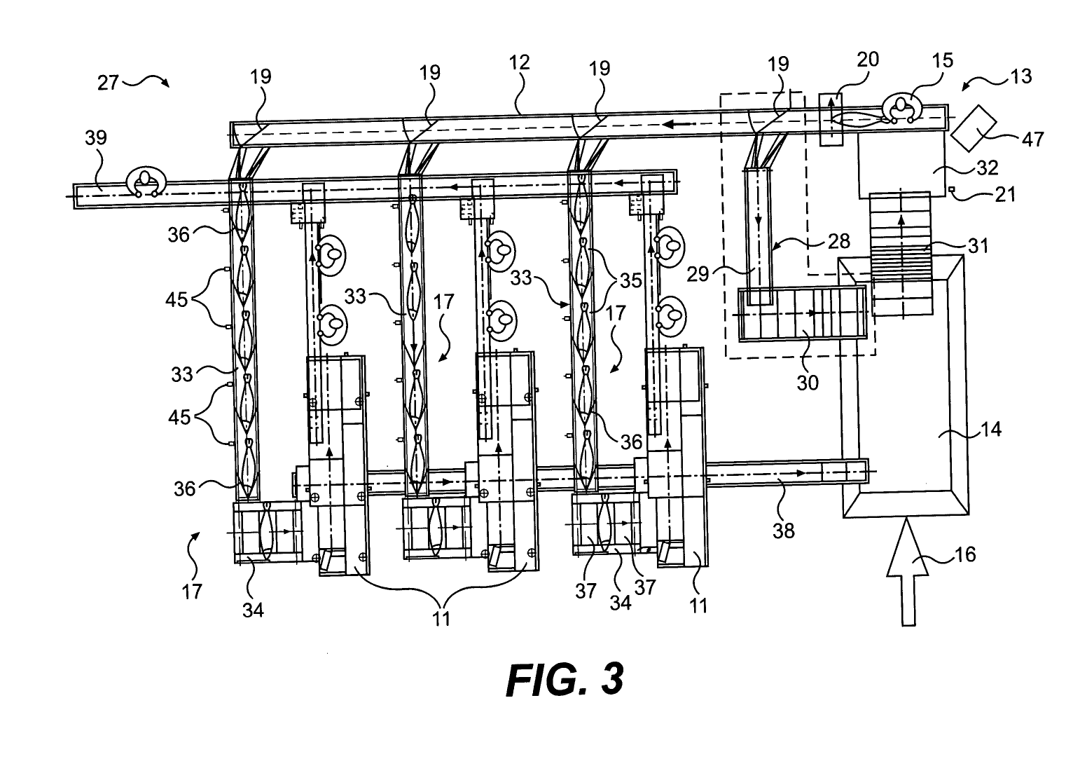

FIG. 3 a further installation according to the invention with three processing machines,

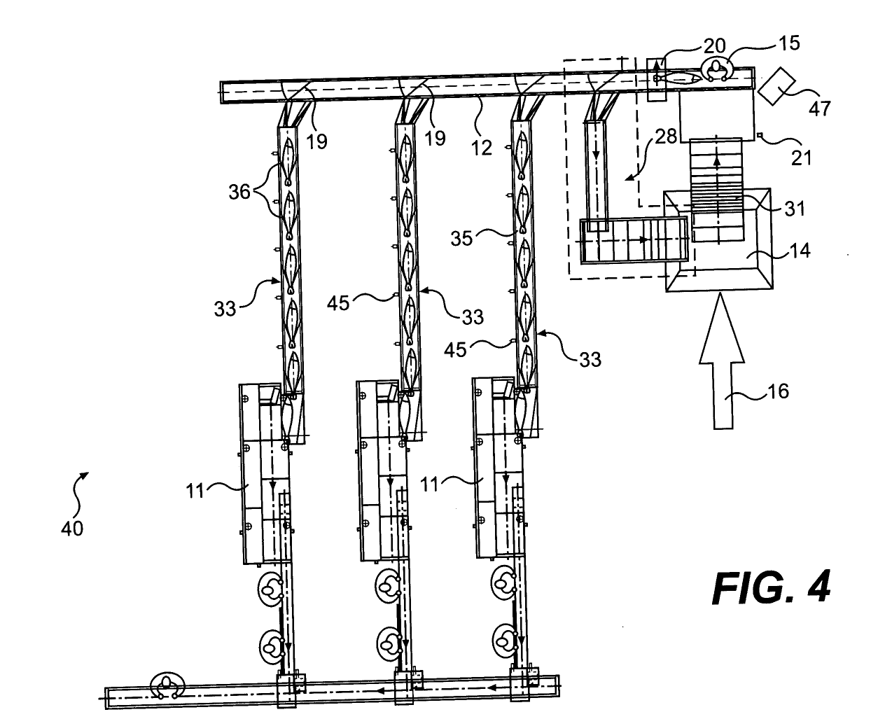

FIG. 4 a further installation according to the invention with three processing machines, and

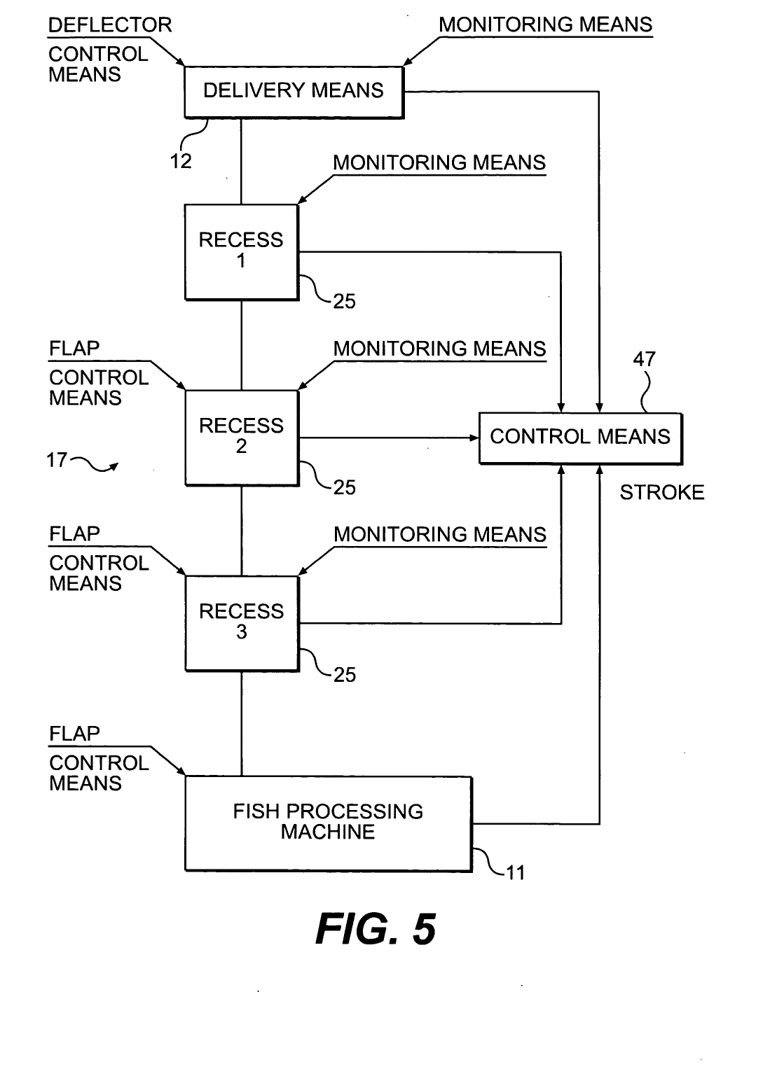

FIG. 5 a schematic view of a circuit diagram for control/regulation of the installation as in FIG. 1.

The installations shown in the figures are used for processing fish. Preferably, the installations are provided for slaughtering and gutting decapitated and undecapitated fish.

In FIG. 1 is shown an installation 10 in which three processing machines 11 are arranged parallel to each other. The processing machines 11 are connected to each other by a central delivery device which is designed as a delivery belt 12. In the input region 13 of the delivery belt 12 is arranged a central storage tank 14 from which an operator 15 can take the fish. The storage tank 14 can be filled with fish by means of a transport device 16. The processing machines 11 are connected to the delivery belt 12 by means 17 for transfer of the fish. In the output region of the processing machines 11 is arranged a discharge belt 18 for carrying away the slaughtered and gutted fish.

The installation 10 has a computer unit (not shown) for control and/or regulation, by means of which all the components can be controlled and/or regulated according to demand and/or priority and/or position. The computer unit is freely programmable, so that individual adaptations, for example due to an extension of the installation 10 by one or more processing machines 11, are possible.

The delivery belt 12 has controllable and/or regulatable deflectors 19 by means of which the fish can be deflected from the delivery belt 12 in the direction of the processing machine 11 being controlled at the time. The deflectors 19 are designed as pivotable flaps in the shown embodiment. Other actuators, e.g. slides or drivers, can also be provided for conveying the fish from the delivery belt 12. It is crucial that the fish receive an impulse transversely to the longitudinal direction of the delivery belt 12 which is great enough to move the fish. Furthermore, the delivery belt 12 has belt markings (not shown) which make it possible and easier to lay the fish on the delivery belt 12 in an exact position. In the region of the delivery belt 12, behind the region 13 of laying or inputting the fish on the delivery belt 12 in the direction of transport (see arrow in FIG. 1), and before the first processing machine 11, are arranged means 20 for detecting the fish. The means 20 is designed as a sensor for recording and/or detecting the position and/or gathering geometrical data of the fish. However, other ordinary optical and mechanical measuring devices can be used as well.

In the region of the storage tank 14 is likewise arranged a monitoring means which in the present case is designed as a sensor 21. The sensor 21 serves to monitor the level of the storage tank 14 or to regulate the quantity thereof.

The means 17 for transfer can be designed as an active or passive conveying element. A combination of active and passive means can be used as well. In the embodiment according to FIG. 1, the means 17 is designed as a passive conveying element 22. This means that the fish are transported automatically, without additional drive means or conveying aids. Preferably, the conveying element 22 is essentially composed of a chute (see in particular FIGS. 1 and 2). The chute is approximately L-shaped and inclined in two planes, so that each fish slides automatically, essentially just by force of gravity, into its final input position. The chute has a first section 23 which is preferably composed of a smooth metal sheet or the like, on which the fish are delivered individually to the second section 24. The second section 24 has several receptacles 25, each receptacle 25 serving to receive a single fish. The receptacles 25 are arranged in such a way that the fish lie with their longitudinal axis roughly parallel to the longitudinal axis of the processing machine. At least the receptacle 25 closest to the processing machine 11 is arranged in such a way that the fish is aligned parallel directly in the region of the input position into the processing machine 11. The other receptacles 25 can also be arranged in a fan shape.

The receptacles 25 in section 24 of the chute are separated from each other by separating means. The separating means are designed as pivotable flaps 26 in the shown embodiment. However, slides and other movable elements can also be used for division into individual compartments. Each receptacle 25 has a monitoring means 45 which enables at least the presence and the absence of a fish, that is, a yes/no query. Mechanical, optical or other ordinary measuring means operating with or without contact can be used as the monitoring means 45. It is also possible to pick up further measurable variables in addition to the yes/no query. Each receptacle 25 has a positioning aid for the fish so that, in the example shown in FIG. 1, they slide tail first into the receptacle and lie in the receptacle 25 in the exact position for further processing by means of the positioning aid. The positioning aid simultaneously serves as an abutment, so that the fish do not slip out of the receptacle 25.

Associated with the chute, preferably in the transition region from the delivery belt 12 to the section 23, is a means for the delivery of liquids, namely in particular water, lubricant-enriched water or the like, for assisting the process of transport over the chute.

The whole conveying element 22 is connected to a computer unit for control and/or regulation of all the components. In particular the flaps 26 are individually controllable, wherein the computer unit of the conveying element 22 is operatively connected to the computer unit 47 of the whole installation 10.

In FIG. 3 is shown a further embodiment of an installation 27 according to the invention. Essentially, the installation 27 is constructed similarly to the installation 10, so that the same reference numbers are used for the same parts. In addition to the processing machines 11, the delivery belt 12, the storage tank 14 and the transport device 16, between the means 20 for detecting the fish on the delivery belt 12 and the first processing machine 11 in the direction of transport is arranged a return device 28 which extends from the delivery belt 12 over a chute 29 and a conveyor 30 into the storage tank 14. The return device 28 can be a chute, a belt or any other known element. In the embodiment according to FIG. 3, the storage tank 14 is connected by a conveyor 31 to a storage recess 32 from which the operator 15 can take the fish. Due to this bypass arrangement, it is possible for fish which are detected by the means 20 as being incorrectly positioned and/or surplus can be returned to the storage tank 14. The means 20 further serves to supply the computer unit 47 with information which it needs for control of the deflectors 19.

The means 17 for transfer in this embodiment is composed of a storage buffer 33 and a single-stroke unit 34. The single-stroke unit 34 is arranged behind the storage buffer 33 in the direction of transport of the fish. The storage buffer 33 is designed as a chute, so that the fish slide down on the slope by force of gravity. It is, however, also possible for the storage buffer 33 to be designed as an active conveying means, namely as a continuous conveyor belt or the like. The single-stroke unit 34 is optionally designed as a continuous conveyor belt, as a cassette, drum conveyor or other ordinary conveying element. The single-stroke unit 34 serves as a link member between the storage buffer 33 and the processing machine 11 arranged parallel to the storage buffer 33, and as a positioning aid for the fish. The nested arrangement in which the direction of transport of the storage buffer 33 runs counter to the direction of transport of the processing machines 11, leads to low area requirements of the installation 27.

The storage buffer 33 has individual compartments 35 into which the fish slide in their longitudinal extent. Pivotable flaps 36 or the like separate the individual compartments 35 from each other. In the embodiment shown, five compartments 35 are provided. The number of compartments 35 is variable, however. At the end of the storage buffer 33 the fish are transferred to the single-stroke unit 34, the fish then being conveyed in the single-stroke unit 34 transversely to their longitudinal extent. The single-stroke unit 34 is inclined in such a way that the fish pass through inside the single-stroke unit 34 head first and then slide against a stop in the tail direction, so that they are aligned in position. The single-stroke unit 34 prepares the fish arriving at the processing machine 11 head first, or deflects them in such a way that the fish can be processed in the processing machines 11 which require positioning tail first. In the single-stroke unit 34 are also formed several receptacles 37, wherein all the receptacles 37 must always be occupied, as the single-stroke unit 34 is coupled to the stroke of the processing station. All the compartments 35 and preferably also all the receptacles 37 have monitoring means 45, as already described in connection with the installation 10, to monitor the presence and/or the position and/or further data of the fish.

All the processing machines 11 are connected to a further return belt 38 with which untreated fish can be guided from the processing machines 11 to the central storage tank 14. Behind the processing machines 11 in the direction of transport are arranged discharge belts 39 for subsequent treatment and for quality control of the slaughtered and gutted fish.

The embodiment of the installation 40 according to FIG. 4 essentially corresponds to parts of the installation 27, so that identical parts are given the same reference numbers. By contrast with the installation 27, the means 17 for transfer consists only of the storage buffer 33 which delivers the fish tail first directly to the processing machines 11. Both the storage buffers and the processing machines 11 have the same direction of transport, so that deflection of the fish is not necessary.

The invention is not confined to the embodiments shown. Rather, installations with different numbers of processing machines 11 are conceivable too, which are arranged as in a bus system in parallel, offset or obliquely adjacent to each other, wherein the processing machines 11 are connected to each other by the common delivery belt 12. The installations can also have further signal and safety elements. For instance, in the input region 13 of the delivery belt 12 can be provided an optical or acoustic signal which signals to the operator 15 that no more fish are to be laid on the delivery belt 12. Arrangements other than those shown, of the machines 11 relative to each other and of the machines 11 in relation to the delivery belt 12, are possible too.

Below, the process cycle of the individual plants is described. The method serves for the processing of fish in particular within a weight range from about 2 to 11 kg. The central storage tank 14 is adequately supplied with fish by means of the transport device 16, so that the operator 15 can take the fish continuously out of the storage tank 14 or storage recess 32. This separation of the fish when they are taken out is done by one operator 15 for all connected processing machines 11. The operator 15 lays the fish individually and in alignment on the delivery belt 12. Either the belt markings or the means 20 which sorts out wrongly detected fish, help here. In the embodiments shown in FIGS. 1 and 4, the fish position is tail first and with the dorsal fin to the operator 15. However, depending on the application, a different positioning can be selected. In FIG. 3, for example, the fish are laid on the delivery belt 12 head first and dorsal fin facing away from the operator 15. The means 20 for monitoring checks the fish position. Depending on the setting from the computer unit with respect to the required position, the required geometrical data and other measured parameters, that is, after comparison with nominal data or nominal position, in case of a positive result the fish is conveyed further on the delivery belt 12. In case of a negative result, that is, when the fish is e.g. wrongly positioned or defective, the fish is guided by means of the deflector 19 onto the return device 28 and from the latter back into the storage tank 14.

The fish which is guided further on the delivery belt 12 in the direction of the processing machines 11 is now, depending on demand and priority—both are determined by the computer unit in coordination with the means 20, the monitoring means 45 and the other sensors and the like—deflected by the deflectors 19 onto the means 17 for transfer. The deflectors 19, which are usually open and which allow transport of the fish on the delivery belt 12, are swung out for a short time, so that the fish is turned about 90° at the desired position by the thrust movement and/or the impulse, and conveyed from the delivery belt 12. Depending on the installation, the fish then passes onto the conveying element 22 or the storage buffer 33. In the embodiment according to FIG. 1, the flaps 26 of all the receptacles 25 are usually closed, so that the fish stays briefly in the first receptacle 25 each time. The monitoring means 45 detect the presence of the fish and indicate this to the computer unit 47. After a period of calming of the fish, the flaps 26 open to the adjacent receptacle 25 which is located one step closer to the processing machine 11 when the monitoring means 45 has released the receptacle 25 due to the absence of a fish. The fish then slides one position further down. Thus, the fish pass step by step directly into the input region of the processing machines 11. The processing machine 11 opens its own single-stroke flap 46 (see FIG. 2) in its working stroke, so that the fish lying immediately in front of the single-stroke flap 46 drops into the processing machine 11 with its longitudinal axis parallel to the discharge edge of the processing machine 11. The single-stroke flap 46 closes immediately after fish discharge and signals the absence of a fish. In other words, this means that the processing machines 11 determine or preset the demand. The computer unit then controls delivery of the fish according to a preset programme.

In the installations 27 and 40 according to FIGS. 3 and 4, the flaps 36 of the storage buffer 33 are basically open, so that the fish always slide or are conveyed into the free compartment 35 closest to the processing machine 11. The storage buffer 33 is therefore filled up, starting from the processing machine 11.

In the installation 40 according to FIG. 4, the fish are guided directly out of the storage buffer 33 to a point in front of the single-stroke flap 46 of the processing machine 11. Transport in the storage buffer 33 is effected either actively by a conveyor belt or the like, or passively by a chute. With the method of the installation 27 according to FIG. 3, the fish are transferred from the storage buffer 33 to the single-stroke unit 34, this being head first. The fish hit an abutment with their heads and, due to the inclination of the single-stroke unit 34, slide in the tail direction until they have found their final and predefined position. The fish are then likewise guided from one receptacle 37 to another 37 until they lie immediately in front of the single-stroke flap 46 of the processing machine 11. It is crucial here that the single-stroke unit 34 must basically be fully loaded because, unlike a storage device, it is linked to the stroke of the processing machine 11.

In the event that the operator 15 generates an empty stroke, the latter is compensated by the storage or stock function of the conveying element 22 and/or storage buffer 33, so that the processing machines 11 are continuously supplied with fish. Therefore, there is also the possibility of fully automatically laying and aligning the fish on the delivery belt 12, so that the installations can operate without permanently tying an operator 15 to the installation.

With the aid of FIG. 5, it is once again shown with reference to the installation 10 how control/regulation of the installation 10 or of delivery to the processing machines 11 functions. The central control system is connected both to the delivery belt 12 (delivery means in FIG. 5) and to the processing station 11 (fish treatment machine in FIG. 5). Between the delivery belt 12 and the processing station 11 is arranged the means 17 for transfer. The receptacles 25 (recesses 1 to 3 in FIG. 5) are also connected to the control system. With the aid of the data and information transmitted from the monitoring means 20 and 45, the control system controls the cycle of the installation 10.

1. Installation for the preparation and processing of fish, in particular for the slaughter and gutting thereof, essentially including
a) a transport device (16) for fish,
b) a central storage tank (14) for holding or for collecting the fish delivered, and
c) at least two processing machines (11) for processing fish,
d) a central delivery device for continuously delivering the fish to each processing machine, characterised in that
e) in the region of each processing machine for processing the fish the delivery device comprises means for transfer of the fish from the delivery device to each processing machine, wherein
f) the means for transfer are designed in such a way that the fish move automatically to the respective input position of the processing machine.

2. Installation according to claim 1, characterised in that several processing machines for slaughtering and gutting fish are arranged parallel to each other, wherein the processing machines are connected to each other by the central delivery device, namely by a delivery belt.

3. Installation according to claim 1, characterised in that the installation has a central computer unit for control and/or regulation, by means of which all components can be controlled and/or regulated according to demand and/or priority and/or position.

4. Installation according to claim 3, characterised in that the computer unit or control/regulation system is freely programmable.

5. Installation according to claims 1, characterised in that the delivery belt has controllable and regulatable deflectors by means of which the fish can be deflected from the delivery belt in the direction of the processing machine being controlled at the time.

6. Installation according to claims 1, characterised in that the delivery belt has belt markings.

7. Installation according to claims 1, characterised in that the region of the delivery belt, behind the position of laying the fish on the delivery belt in the direction of transport of the fish and before the first processing machine are arranged means for detecting fish.

8. Installation according to claim 7, characterised in that the or each means is designed as a sensor for recording and/or for detecting the position and/or for gathering geometrical data of the fish.

9. Installation according to claims 1, characterised in that between the sensor and the first processing machine in the direction of transport of the fish is arranged a return device or the like with which fish are detected by the sensor as being incorrectly positioned and/or surplus can be returned to the storage tank.

10. Installation according to claims 1, characterised in that in the region of the storage tank is arranged a monitoring means for quantitative regulation inside the storage tank.

11. Installation according to claims 1, characterised in that each processing machine for slaughtering and gutting is connected to a central discharge belt.

12. Installation according to claim 1, characterised in that the means for transfer is designed as an active conveying element.

13. Installation according to claim 12, characterised in that the active conveying element is essentially composed of a storage buffer.

14. Installation according to claim 13, characterised in that the conveying element additionally has a single-stroke unit, wherein the single-stroke unit is arranged behind the storage buffer in the direction of transport of the fish.

15. Installation according to claim 13, characterised in that the storage buffer and/or the single-stroke unit is designed as a continuously moving belt.

16. Installation according to claim 14, characterised in that the single-stroke unit is designed as a cassette.

17. Installation according to claim 13, characterised in that the storage buffer is designed for holding and for transport of the fish tail or head first in their longitudinal direction.

18. Installation according to claim 13, characterised in that the storage buffer comprises several holding compartments for holding a single fish each, wherein the holding compartments are separated from each other by pivotable flaps, slides or the like.

19. Installation according to claim 18, characterised in that associated with each holding compartment is a monitoring means.

20. Installation according to claim 14, characterised in that the single-stroke unit is designed for transport of the fish in their transverse direction.

21. Installation according to claim 14, characterised in that the single-stroke unit is designed as a drum conveyor or active conveyor belt, wherein drum conveyor or conveyor belt are designed in such a way that the fish lie with their tail end in a predefined position.

22. Installation according to claim 1, characterised in that the means for transfer is designed as a passive conveying element.

23. Installation according to claim 1, characterised in that the means for transfer is composed of a combination of active and passive conveying elements.

24. Installation according to claim 1, characterised in that the means for transfer is designed as a conveying element.

25. Conveying element for linking a central delivery device to a processing machine for processing fish, essentially including a chute, characterised in that the chute is inclined in two planes in such a way that each fish automatically moves from the delivery device over the chute directly into the input position of the processing machine.

26. Conveying element according to claim 25, characterised in that the chute comprises at least one receptacle for the storage of a fish.

27. Conveying element according to claim 25, characterised in that several receptacles are provided for storage.

28. Conveying element according to claim 26, characterised in that the individual receptacles are separated from each other by pivotable flaps, slides or the like.

29. Conveying element according to claim 28, characterised in that the flaps, slides or the like are individually controllable.

30. Conveying element according to claim 26, characterised in that associated with each receptacle is a monitoring means.

31. Conveying element according to claim 26, characterised in that each receptacle comprises positioning aids for the fish.

32. Conveying element according to claim 25, characterised in that the conveying element is connected to a computer unit for the control and/or regulation of all components.

33. Conveying element according to claim 25, characterised in that associated with the chute is a means for delivery of liquids.

34. Conveying element according to claim 26, characterised in that the last receptacle before the processing machine is designed or arranged in such a way that the fish is arranged with its longitudinal axis essentially parallel to the discharge edge of the processing machine.

35. Method for the automated processing of fish, essentially including the following steps:
delivery and collection of the fish in a central storage tank,
separation of the fish,
manual alignment of the fish into a predefined position,
automated processing of the fish,
characterised in that before automated processing the fish are
laid on a central delivery device and aligned and then
delivered to the processing machines for processing, wherein
the fish are passed through from the delivery device by a means for transfer to the respective processing machine according to demand and priority.

36. Method according to claim 35, characterised in that the delivery device supplies several apparatuses for slaughtering and gutting.

37. Method according to claim 35, characterised in that with monitoring means and a master computer unit for the control and/or regulation of all components with reference to demand messages and/or priority commands of the delivery device and/or the processing machines for slaughtering and gutting and/or storage buffers, it is determined where the next fish is deposited each time.

38. Method according to claim 37, characterised in that the individual components, namely in particular the deflectors, pivotable flaps and the like as well as the belt speed of the delivery belt are controlled and regulated separately and in coordination with each other.

39. Method according to claims 35, characterised in that the fish is transported into the region of the selected processing machine and there deflected by the deflector from the delivery device onto the means for transfer to the processing machine.

40. Method according to claims 35, characterised in that the fish is conveyed actively or passively into a receptacle or compartment in the means for transfer, wherein a monitoring means detects the presence or absence of a fish in the receptacle or compartment and sends corresponding commands/signals to the computer unit for transmission of the demand.

41. Method according to claims 35, characterised in that after a calming period the fish is guided into a subsequent receptacle in the direction of the processing machine, provided that the monitoring means of the subsequent receptacle has indicated a demand.

42. Method according to claims 35, characterised in that the fish inside the storage buffer is conveyed or slides downwards as far as possible in the direction of the processing machine, wherein the flaps, which are basically open, close only when the preceding compartment in the direction of transport is occupied.

43. Method according to claims 35, characterised in that the fish is guided stepwise to a point immediately in front of the single-stroke unit or single-stroke flap (46) of the processing machine.

44. Method according to claims 35, characterised in that, after opening of the single-stroke flap, the fish drops into the processing machine with its longitudinal axis parallel to the discharge edge of the processing machine.
